(19) United States
(12) Patent Application Publication
(10) Pub. No.: US 2019/0065418 A1
(43) Pub. Date: Feb. 28, 2019

(54) MESSAGE ROUTING IN A MAIN MEMORY ARRANGEMENT

(71) Applicant: International Business Machines Corporation, Armonk, NY (US)

(72) Inventor: Burkhard Steinmacher-Burow, Esslingen am Neckar (DE)

(21) Appl. No.: 15/689,602

(22) Filed: Aug. 29, 2017

(51) Int. Cl. G06F 13/362; G06F 13/40; G06F 15/173; G06F 13/16; G06F 3/06

(52) U.S. Cl. CPC G06F 13/362; G06F 13/4022; G06F 15/17337; G06F 13/4282; G06F 3/0635; G06F 13/4068; G06F 13/1673

(57) ABSTRACT

A memory hub device can be used to electrically interconnect a set of memory devices to a main memory arrangement. The memory hub device can include a set of ports for connecting memory devices to the memory hub device. The memory hub device can also include a coherence protocol processing circuit configured to process messages received from the memory devices through the ports and through a switch fabric coupled to the ports and to the coherence protocol processing circuit. The switch fabric can be configured to selectively forward messages received from memory devices through the ports to the coherence protocol processing circuit, or to another port used to transmit the message to the another memory device. The coherence protocol processing circuit can be used to process the messages.

### BACKGROUND

The present disclosure relates to the field of computer systems and more specifically to a memory hub device, a memory device and a method for routing messages received by the memory hub device from the memory device.

Modern computer systems generally include a memory architecture having a plurality of individual memory devices. Such memory devices may be used in a main memory arrangement and/or be coupled to the same. Memory devices can, for example, be coupled to the main memory arrangement through a memory hub device. Rapid processing of data within a computer system can depend heavily on the speed at which data and instructions can be retrieved from memory. The action of retrieving data and instructions, in general, can take a significant amount of time relative to an average time required to execute the instructions and process the data. Reducing the time required for data transmission and retrieval can be useful in improving overall data processing performance within a computer system.

### SUMMARY

Various embodiments include a memory hub device for electrically interconnecting multiple memory devices to a main memory arrangement, a memory device and a method for routing messages received by a memory hub device from a memory device. Embodiments of the present disclosure can be freely combined with each other if they are not mutually exclusive.

Embodiments may be directed towards a memory hub device for electrically interconnecting a set of memory devices to a main memory arrangement. The memory hub device can include a first port configured to connect a first memory device of the set of memory devices to the memory hub device. The memory hub device can include a second port configured to connect a second memory device of the set of memory devices to the memory hub device. The first port and the second port can each be configured to receive messages from the first memory device and the second memory device, respectively. The first port and the second port can be configured to transmit messages to the first memory device and the second memory device, respectively. The memory hub device can include a coherence protocol processing circuit configured to process messages received from the first and second memory devices. The memory hub device can include a switch fabric electrically coupled to the first port, to the second port and to the coherence protocol processing circuit. The switch fabric can be configured to selectively forward a first message received from the first memory device through the first port to the coherence protocol processing circuit. The switch fabric can also be configured to selectively forward the first message through the second port to the second memory device.

Embodiments may also be directed towards a memory device, the memory device electrically connected to a memory hub device, the memory device comprising a message formatting circuit. The message formatting circuit can be configured to format a first message, the first message having a destination of the memory hub device. The message formatting circuit can be configured to include, within the first message, information that identifies a second memory device to which the first message is to be forwarded by the memory hub device.

Embodiments may also be directed towards a method for routing messages received by a memory hub device from a memory device of a plurality of memory devices. The memory hub device can have a first port configured to electrically interconnect a first memory device of the plurality of memory devices to the memory hub device. The memory hub device can have a second port configured to electrically interconnect a second memory device of the plurality of memory devices to the memory hub device. The method can include receiving, from the first memory device, through the first port, a first message. The method can also include selecting, with a switch fabric electrically interconnected to the first port, to the second port and a to coherence protocol processing circuit, a forwarding destination for the first message. The method can also include in response to the selection, selectively forwarding, using the switch fabric, the first message to the forwarding destination.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a schematic diagram of a computer system configured for implementing embodiments of the present disclosure.

FIGS. 2A-2C are schematic block diagrams illustrating a memory hub device connected to a plurality of memory devices and paths of messages sent between a processor chip and a memory buffer chip, according to embodiments consistent with the figures.

FIG. 3 is a flow diagram of a method for operation(s) depicted in FIG. 2C, according to embodiments consistent with the figures.

FIG. 4 is a flow diagram of a method for processing a read request, according to embodiments consistent with the figures.

FIG. 5 is a schematic diagram depicting a multi-processor architecture in the form of a multi-processor computer system, configured for implementing embodiments of the present disclosure.

FIG. 6 is a schematic diagram depicting a multi-processor architecture configured for implementing embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

In the drawings and the Detailed Description, like numbers generally refer to like components, parts, steps, and processes.

### DETAILED DESCRIPTION

The descriptions of the various embodiments of the present invention are being presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments can be useful for allowing a switch fabric to selectively decide to forward messages received from a first memory device to a forwarding destination including a second port for transmission of the respective messages to a second memory device, instead of forwarding the received message to the coherence protocol processing circuit for processing. Thus, the switch fabric can enable a memory hub device to directly forward a message received from the first memory device to the second memory device without processing the respective message with the coherence protocol processing circuit. The message routing by the memory hub device may be thereby accelerated, and the time required for transmitting messages from the first memory device to the second memory device through the memory hub device may be reduced.

In embodiments, at least one of the memory devices may include caches of one or more processor chips or they may include at least one memory storage device(s).

According to embodiments, the switch fabric can be configured to decide whether the first message is to be forwarded to the coherence protocol processing circuit or to the second port, based on the content of the first message. Embodiments can be useful for having the switch fabric decide whether to forward a message to a forwarding destination including the coherence protocol processing circuit or to forward the respective message directly to a forwarding destination of another memory device based on the content of the respective message. In particular, the decision may be made without the requirement to access a register to identify a further procedure for handling the respective message. The decision may be made solely on the information contained within the message.

According to embodiments, the content of the first message upon which the switch fabric makes a decision includes a routing tag. A routing tag can be useful in providing, in a compact format, the necessary information needed for the switch fabric to make its decision efficiently.

According to embodiments, the routing tag can be included in a header of the first message. According to embodiments, including the routing tag in the header of the message can be useful in speeding up forwarding of the respective message. The switch fabric therefore only needs to analyze the header of the first message, and not the entire first message, in order to make a routing selection/decision for a forwarding destination. In particular, the routing decision can be made before the entire first message is received. Thus, “cut-through” switching of the message can be enabled. In some embodiments, the routing tag can be located at the beginning of the payload of the message, and in some embodiments, the routing tag is included in metadata of the message.

By way of example, the message may have the following format:

5 bits - route data
8 bits - message type
51 bits - address of memory line
512 bits - [optional according to above type]
Value of memory line.

Depending on the value of the “route data” field and/or of the message type field, the route data contained within the route data field can be used by the memory hub device to route the message to another cache. For example, a replacement value, for example, “b11111,” may indicate that route data field is to be ignored.

According to embodiments, the switch fabric can be configured to forward the first message to the second memory device through the second port using cut-through switching. Embodiments can be useful for allowing the message to not have to be received in its entirety to be forwarded to the second memory device. Cut-through switching can allow a reduction of data latency through the memory hub device. This could for example be useful if a port-to-port connection between a memory device and the memory hub device through which the message is transmitted provides very limited bandwidth. It could also, for example, be useful if the port-to-port connection is a serial connection or is a connection only a few bits wide, e.g., 2 bits or 4 bits. Thus, by starting to send the message from the memory hub device to the second memory device while the respective message is still being received from the first memory device, the time required for transmitting the respective message from the first memory device to the second memory device through the memory hub device can be significantly managed and/or reduced.

According to some embodiments, the switch fabric can be configured to forward the first message to the second memory device after the first message has been received in its entirety. Such “store and forward” embodiments may be useful for reducing the error rate for the transmission of the message from the first memory device to the second memory device. For example, the message may be analyzed by a transmission error detection/correction circuit in order to detect and correct transmission errors of the message before it is forwarded to the second memory device. For example, the content of the message based on which destination the switch fabric decides to forward the message to may be corrupted. By first detecting and correcting the error, it may be ensured that the respective message is sent to the correct memory device.

According to embodiments, the memory hub device can also include a transmission error detection and correction circuit configured to detect and correcting transmission errors of messages received by the memory hub device. Embodiments including the transmission error detection and correction circuit can be useful in enabling the memory hub device to ensure the correctness of the message forwarded to the second memory device and/or ensure that the second memory device is the correct destination of the message. According to embodiments, the routing tag can include transmission error detection and correction data, for example, a parity bit.

According to embodiments, the transmission error detection and correction circuit can be configured to detect and correct transmission errors within the first message before or after the first message has been transmitted by memory hub device. Embodiments can be useful for analyzing the message by using the transmission error detection and correction circuit before the message is transmitted. Thus, it can be ensured that only correct or corrected first messages are transmitted. Some embodiments can be useful for allowing the first message or a copy the first message generated for that purpose to be analyzed by the transmission error detection and correction circuit in order to detect and correct transmission errors after the first message has already been transmitted, without slowing down the transmission of the respective message. In other words, the transmission and the detection/correction are performed independently from each other. For example, the error detection and correction may be performed after the forwarding of the respective message to the memory device has been started and/or finished.

According to some embodiments, the transmission error detection and correction circuit can be configured to forward the corrected first message to the second port for transmitting the first message to the second memory device. Embodiments can have the beneficial effect that a corrected first message can be transmitted to the second memory device in addition or as an alternative to an erroneous first message. In particular, the corrected first message may be transmitted by the memory hub, if an error was detected and corrected. The message may, for example, have been sent to an incorrect memory device due to a corruption of the content of the message indicating to which memory device the switch fabric was to forward the respective message. After the error has been detected and corrected, the corrected message may be sent to the correct destination memory device.

According to embodiments, the switch fabric can be configured, if the first message is forwarded to the second port for transmitting the first message to the second memory device, to further generate a copy of first message and forward the copy to the coherence protocol processing circuit for storage. According to embodiments, a coherence protocol processing circuit can be useful for receiving a copy of the first message for processing, without slowing down the transmission of the respective message from the memory hub device. For example, the coherence protocol processing circuit can analyze the message and update a coherence register based on the result of the analysis. The memory hub device may also store the copy of the message in a local memory. In the event that the memory hub receives a request for the respective message, the message does not need to be retrieved from the first or second memory device, but the memory hub device can be enabled to provide the respective message using the copy stored in the local memory.

According to embodiments, the memory hub device can also include a message formatting circuit configured to formatting a second message to be transmitted to the first memory device requesting the first message to be sent to memory hub. The second message can include content to be copied into the first message. The content can identify the second memory device to be the target or destination of the first message. Including the content, e.g., a routing tag, in the request for the first message can be useful for rapidly and efficiently including the content in the first message, even though the respective message does not originate from the second memory device, i.e., the final target, but from the memory hub device. In particular, the memory hub device may thus ensure that the first message includes the correct content enabling the switch fabric to decide whether to forward the respective message directly to another memory device or to forward the message to the coherence protocol processing circuit.

According to embodiments, the first message can include data stored within the first memory device. The coherence protocol processing circuit can be further configured to initiate the message formatting circuit to format the second message upon processing a third message through the second port received from the second memory device. The third message can requests the data stored within the first memory device be sent to the second memory device. According to embodiments, data stored within the first memory device can be rapidly and efficiently accessed by the second memory device through the memory hub device. The memory hub device may be enabled to establish consistency and ensure a rapid and efficient data transmission. In some embodiments, the memory hub device can be a memory hub chip and/or memory buffer chip.

According to embodiments, the message formatting circuit of the memory device can be configured to include the information into the first message by copying the information from a second message received by the memory device from the memory hub device. The second message can request that the first message be sent to memory hub. In some embodiments, the memory device can be a cache of a processor chip.

The method for routing messages through the memory hub device can be suitable for operating each of the embodiments described herein. According to embodiments, the switch fabric of the memory hub device can decide or select whether the first message is to be forwarded to the coherence protocol processing circuit or to the second port, based on the content of the first message. The method can also include formatting a second message with a message formatting circuit of the memory hub device. The second message requests that the first message be sent to memory hub and can include content to be copied into the first message. The content identifies the second memory device to be the destination or target of the first message. The second message can be transmitted to the first memory device through the first port.

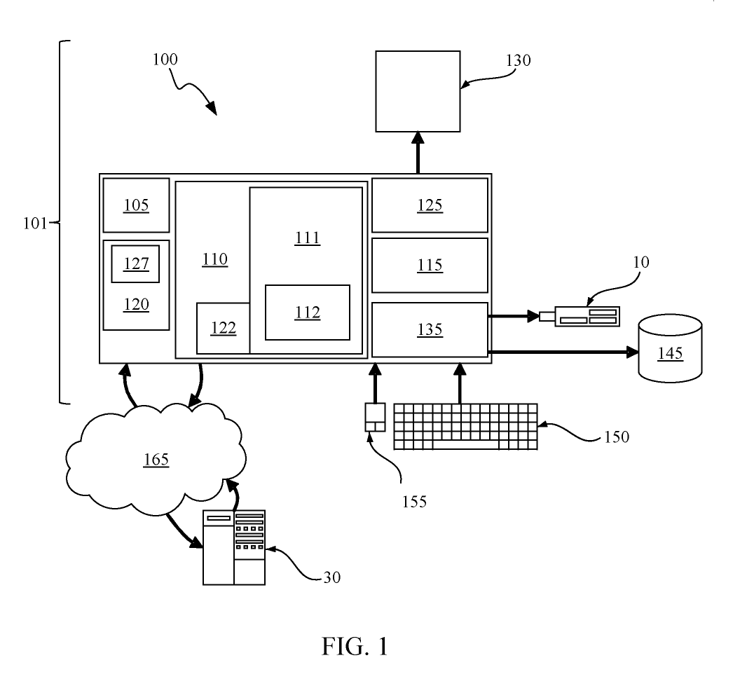

FIG. 1 depicts a general computing system 100 suited for implementing embodiments of the present disclosure. The general system 100 may be, for example, implemented in form of a server, an embedded computerized system or general-purpose digital computer, such as a personal computer, workstation, minicomputer, or mainframe computer. The most general system 100 therefore includes a general-purpose computer 101.

The computer 101 may in particular be configured as a server, i.e., being optimized for a high-speed data exchange with a large number of clients. The computer 101 may further possess a large processing, i.e., central processing unit (CPU) capacity and/or large main memory capacity. The software in memory 110 can also include a server software application for processing a large number of requests by clients.

In some embodiments, as depicted in FIG. 1, the computer 101 can include a processor 105, main memory 110 coupled to a memory controller 115, and at least one input and/or output (I/O) device or peripheral 10 and 145 that are communicatively coupled through a local input/output controller 135. The input/output controller 135 can include, but is not limited to, at least one bus or other wired or wireless connections. The input/output controller 135 can have additional elements, omitted for simplicity, such as controllers, buffers/caches, drivers, repeaters, and receivers, to enable communications. The local interface can also include address, control, and/or data connections to enable appropriate communications among the described components. As described herein, the I/O devices may generally include any generalized portable storage medium 10, such as a Universal Serial Bus (USB) flash drive, or a database 145.

The processor 105 can be a hardware device for executing software that is stored in memory 110. The processor 105 can be any custom or commercially available processor, a CPU, an auxiliary processor among several processors associated with the computer 101, a semiconductor-based microprocessor, e.g., a microchip or chipset, a microprocessor, or generally any device configured to execute software instructions. The processor 105, also referred to as “processor chip,” can include an address translation device operable for translating physical addresses of a memory line to a location within a memory device of main memory 110. Thus, the processor 105 may be enabled to access memory lines stored in the main memory 110 in a rapid and efficient way. Methods described herein may, for example, be implemented in software, including firmware, hardware/processor 105, or a combination thereof.

The memory 110, also referred to as “main memory,” can include any one or combination of volatile memory devices, e.g., random access memory (RAM, such as dynamic random-access memory (DRAM), static random-access memory (SRAM), synchronous dynamic random-access memory (SDRAM), etc.) and nonvolatile memory devices, e.g., read-only memory (ROM), erasable programmable read only memory (EPROM), electrically erasable programmable read only memory (EEPROM), or programmable read-only memory (PROM). The memory 110 may have a distributed architecture, where additional modules are situated remotely from one another, but can be accessed by the processor 105. In particular, the main memory 110 may include multiple memory devices, each of which may include a memory capacity, i.e., memory space, including at least one memory portion. A memory portion may include at least one physical storage cell.

The memory 110 can include software that includes computer-readable software instructions 112. The software in memory 110 may further include a suitable operating system (OS) 111. The OS 111 can be used to control the execution of other computer programs, such as possibly software 112.

In some embodiments, a keyboard 150 and mouse 155 can be coupled to the input/output controller 135. Other output devices such as the I/O devices 145 may include input devices including, but not limited to, a printer, a scanner, microphone, and the like. The I/O devices 10, 145 may also include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The I/O devices 10, 145 can be any generalized cryptographic card or smart-card known in the art. In some embodiments, the system 100 can also include a display controller 125 coupled to a display 130. In some embodiments, the system 100 can also include a network interface for coupling to a network 165. The network 165 can be an Internet protocol (IP) based network configured for communication between the computer 101 and any external server, client through a broadband connection. The network 165 can transmit and receive data between the computer 101 and external systems 30, which can be involved to perform part or all of the operations of the methods discussed herein. In some embodiments, network 165 can be a managed Internet Protocol (IP) network administered by a service provider. The network 165 may be implemented in a wireless fashion, e.g., using wireless protocols and technologies, such as wireless fidelity (Wi-Fi), Worldwide Interoperability for Microwave Access (WiMAX), etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 101 is a personal computer (PC), workstation, intelligent device or the like, the software in the memory 110 may further include a basic input output system (BIOS) 122. The BIOS is a set of essential software routines that initialize and test hardware at startup, start the OS 111, and support the transfer of data among the hardware devices. The BIOS can be stored in ROM so that the BIOS can be executed when the computer 101 is activated.

When the computer 101 is in operation, the processor 105 is configured for executing software 112 stored within the memory 110, to communicate data to and from the memory 110, and to generally control operations of the computer 101 according to the software. The methods described herein and the OS 111, in whole or in part, but generally the latter, are read by the processor 105, possibly buffered within the processor 105, and then executed.

Software 127 can be stored on any computer-readable medium, such as storage 120, for use by, or in connection with, any computer-related system or method. The storage 120 may include a disk storage unit such as hard disk drive (HDD) storage device.

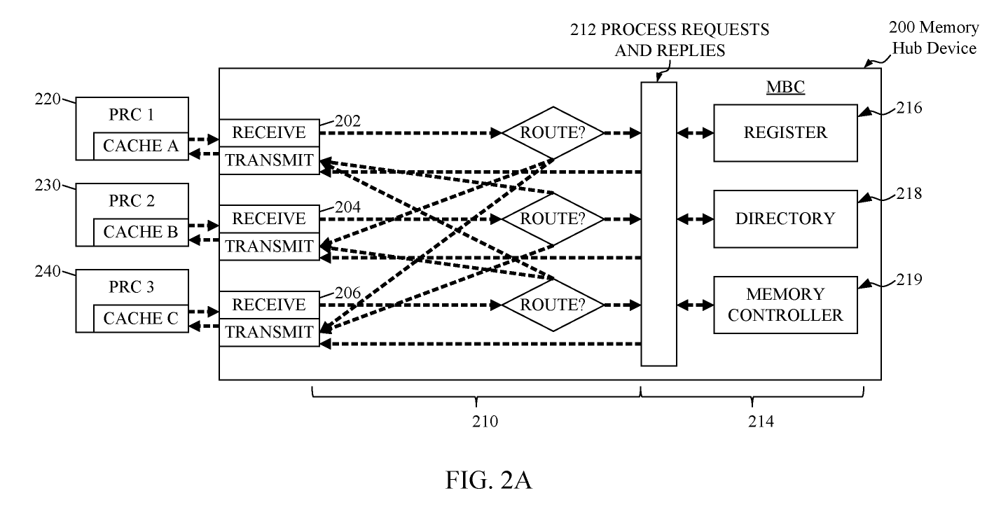

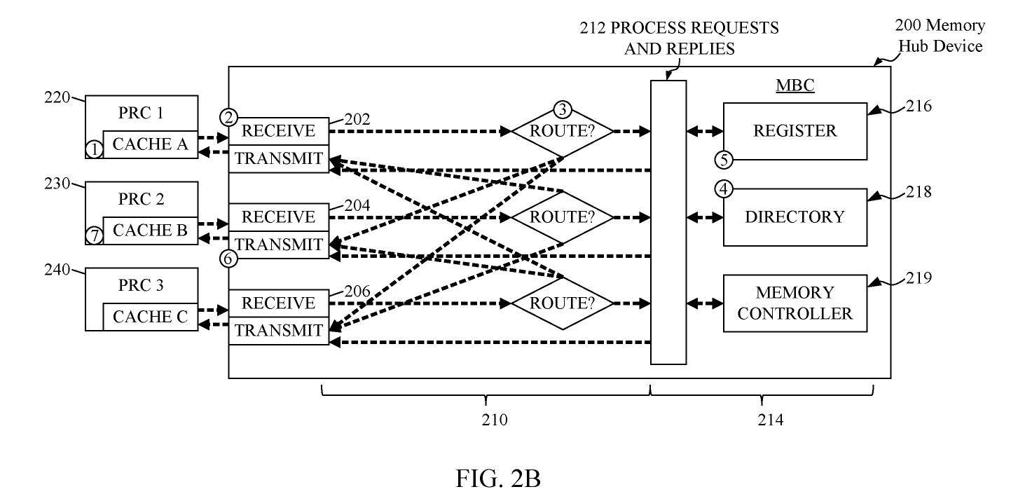

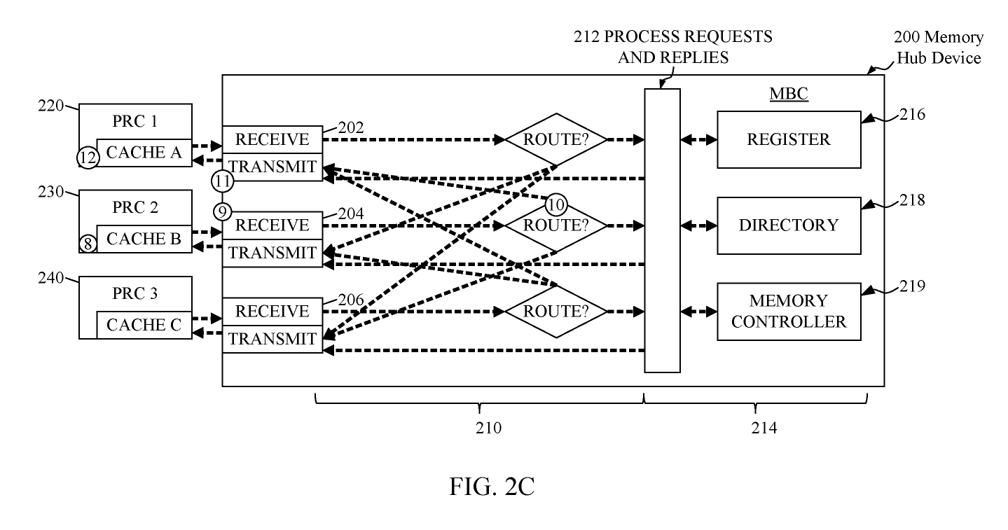

FIG. 2A depicts a schematic block diagram of a memory hub device 200 which is connected with a plurality of memory devices 220, 230 and 240. In some embodiments, the memory hub device 200 is can have the form of a memory buffer chip. The memory buffer chip 200 can include a port 202, 204 and 206 for each of the memory devices 220, 230 and 240. Each of the ports 202, 204 and 206 can be configured to receive messages from the memory devices 220, 230 and 240 that it is connected to, and to transmit messages to the respective memory devices 220, 230 and 240. The memory buffer chip 200 can also include a switch fabric 210 which is electrically interconnected to the ports 202, 204 and 206 and to a coherence protocol processing circuit 214. The switch fabric 210 and the coherence protocol processing circuit 214 may communicate with each other through a bus 212 of the coherence protocol processing circuit 214 which handles process requests and replies exchanged between the switch fabric 210 and the coherence protocol processing circuit 214. The coherence protocol processing circuit 214 can also include a register 216 for registering/storing outstanding requests. The coherence protocol processing circuit 214 can also include a coherence directory 218 used to ensure coherence of the memory architecture that the memory buffer chip 200 is part of. The coherence protocol processing circuit 214 can also include a memory controller 219, which can be used for controlling access to a local main memory module, for example, a dual in-line memory module (DIMM)/DRAM, connected with the memory buffer chip 200.

In some embodiments, the memory devices 220, 230 and 240 can each be included within a processor chip, in the form of CACHE A, CACHE B and CACHE C, respectively.

FIG. 2B illustrates the path of a message being sent from CACHE A of the processor chip 220 to the memory buffer chip 200 requesting data currently handled by CACHE B of processor 230. A request for providing the data is generated in operation 2 by CACHE A of processor chip 220. In operation 2 the request is sent to the memory buffer chip 200 and received through the port 202. The switch fabric 210 checks, in operation 3, whether the request includes a routing tag. If the request does not include a routing tag, it is forwarded to the coherence protocol processing circuit 214. Using the coherence directory 218, the coherence protocol processing circuit 214 determines that the requested data, e.g., a memory line, is currently handled by the processor chip 230. In operation 5, the coherence protocol processing circuit 214 generates a second request, which is recorded by the register 216 requesting the data from the processor chip 230. In operation 6 the second request is sent through port 204 to processor chip 230. In operation 7 processor chip 230 receives the second request from the memory buffer chip 200. The second request includes a routing tag identifying the processor chip 220.

FIG. 2C depicts the path of a reply to the second request of FIG. 2B. In operation 8, the processor chip 230 generates a reply to the second request. When generating the reply, the routing tag is copied from the received second request to the reply. The reply can also include the data requested by the processor chip 220 according to the first request. In operation 9, the reply is sent from processor chip 230 and received by the memory buffer chip 200 through port 204. In operation 10, the switch fabric checks whether the reply includes a routing tag. Since the reply includes a routing tag identifying the processor chip 220 as the destination of the reply, the switch fabric decides to forward the reply to port 202 for transmitting the reply to CACHE A of processor chip 220. According to embodiments, the switch fabric may also copy the reply and provide the resulting copy to the coherence protocol processing circuit 214. The coherence protocol processing circuit may update the register of outstanding requests 216, the coherence directory 218 and may store the copy using the memory controller 219 on a local memory module, like a DRAM or a DIMM. In operation 11, the reply is transmitted to the processor chip 220 by the memory buffer chip. In operation 12 the reply is received by CACHE A of processor chip 220.

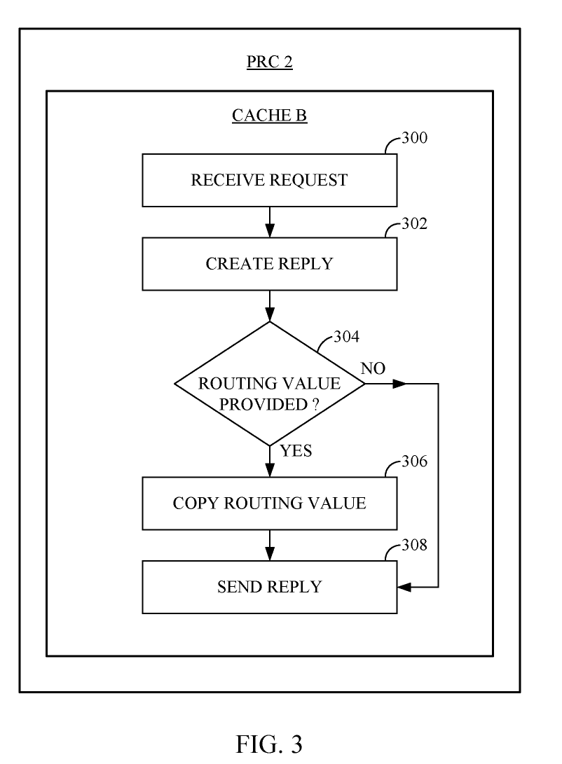

FIG. 3 depicts a flow diagram illustrating operation 8 of FIG. 2C. In operation 300, the request is received by the processor chip from the memory buffer chip. In operation 302, a reply to the received request is created. In operation 304, it is checked, whether the received request provides a routing value. If the received request does not include a routing value, the method is continued in operation 308 by sending the created reply from the processor chip to the memory buffer chip. If received request provides a routing value, the routing value is copied into the created reply in operation 306. After the routing value has been added, the reply is sent in operation 308.

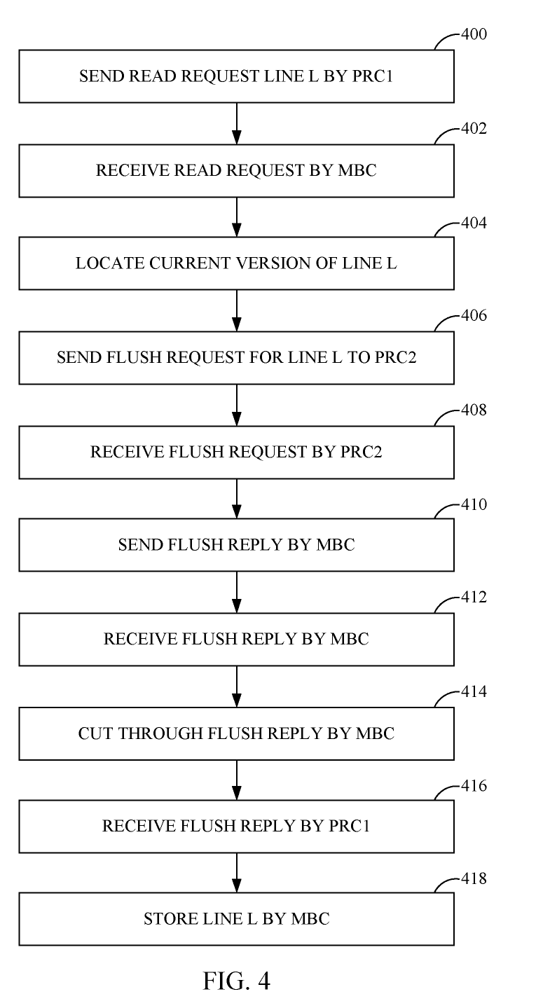

FIG. 4 depicts a flow diagram of a method. In operation 400, a read request for a memory line “L” is sent by a first processor chip to a memory buffer chip. In operation 402, the read request is received by the memory buffer chip. In operation 404, the current version of the requested memory line L is located by the memory buffer chip. In operation 406, a flush request for the requested memory line L is created and sent to a second processor chip, which has been identified as the location of the current version of memory line L. The flush request may include a routing value to be copied into a reply to the flush request. In operation 408, the flush request from the memory buffer chip is received by the second processor chip. In operation 410, the second processor chip creates a flush reply to the received request from the memory buffer chip. The routing value including the flush request is copied into the flush reply. The flush reply is sent to the memory buffer chip. In operation 412, the memory buffer chip receives the flush reply from the second processor chip. In operation 414, the memory buffer chip identifies the received flush reply to include a routing value identifying the first processor chip to be the destination of the flush reply. The memory buffer chip transmits the flush reply to the first processor chip using cut-through switching. In other words, the transmission of the flush reply from the memory buffer chip to the processor chip is started before the flush reply has been received in its entirety by the memory buffer chip. In operation 416, the processor chip receives the flush reply in response to the read request sent in operation 400. In operation 418, the memory line L including the flush reply is stored by the memory buffer chip.

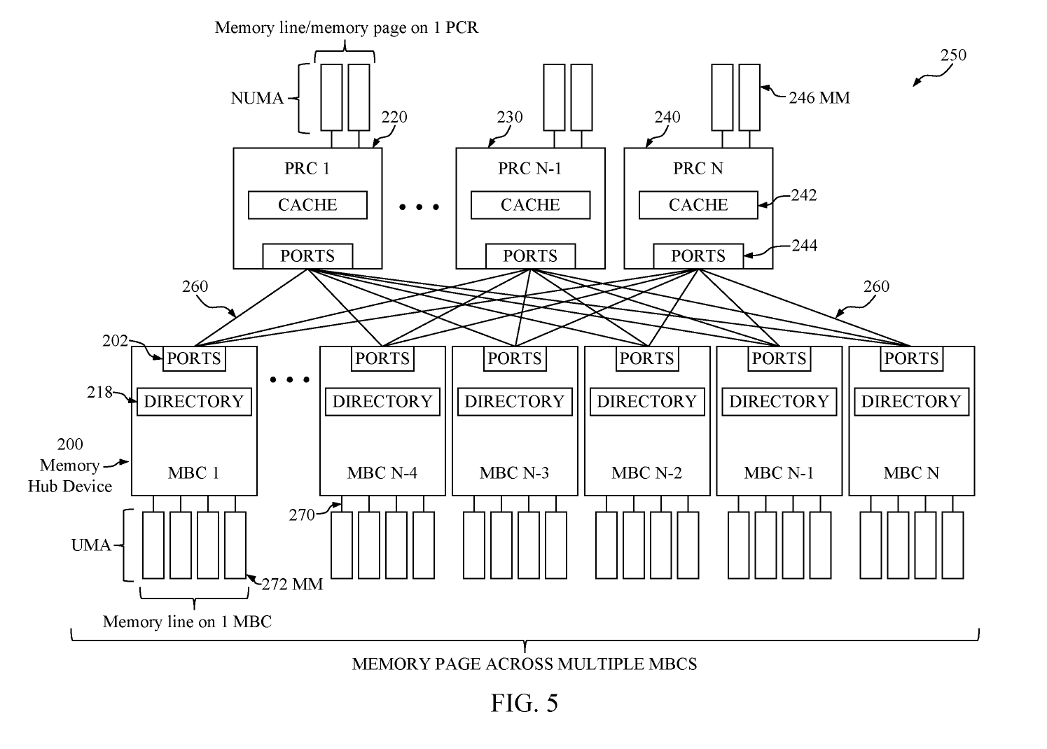

FIG. 5 depicts a multi-processor architecture in form of a multi-processor computer system, for example, a multi-processor server 250 comprising multiple processor chips 220, 230 and 240. The multi-processor server 250 includes a set of memory buffer chips 200. Each processor chip 240 may include a plurality of ports 244. According to an embodiment the number of ports 244 provided per processor chip 240 may equal the number of memory buffer chips 200. Each processor chip 220, 230 and 240 includes a cache 242 for caching memory lines to be processed by the processor chip 240. Thus, each processor chip 220, 230 and 240 includes a memory device. For the set of processor chips 220, 230 and 240 of the server 250, the processor chips 220, 230 and 240 may or may not be identical. Application software may be executed on one or more processor chips 220, 230 and 240 and thus a given application may implicitly or explicitly exploit and benefit from similar or different processor chips 220, 230 and 240.

Each memory buffer chip 200 may include a plurality of local memory modules 272, e.g., DIMMs comprising a number of dynamic random-access memory (RAM) integrated circuits (ICs). Thus, each memory buffer chip 200 implements a memory hub device. Each memory buffer chip 200 can also include a plurality of ports 202. For example, the number of ports 202 per memory buffer chip 200 may be equal to the number of processor chips 220, 230 and 240. In addition, for memory lines stored in the memory modules 272 local to the respective memory buffer chip 200, each memory buffer chip 200 may include a coherence directory 218 for implementing directory-based coherence for a line cached in the cache 242 of one or more processor chips 220, 230 and 240. For the set of memory buffer chips 200 of the server 250, all the memory buffer chips 200 may be the same or similar with each memory buffer chips 200 performing similar functions. Application software may be executed on one or more processor chips 240 and thus performance of a given application generally benefits from memory being served by many and similar memory buffer chips 200, with each particular memory address being served by a single predefined memory buffer chip 200.

Each processor chip 220, 230 and 240 may be electrically connected with each memory buffer chip 200 e.g., through a bidirectional point-to-point communication connection 260, for example a serial communication connection. Thus, each processor chip 240 may be provided with memory access to each of the memory modules 272 local to one of the memory buffer chips 200. The access to the memory modules 272 may be provided based on a uniform memory access (UMA) architecture. A given memory line, i.e., cache line, may be stored on one or more memory modules 272 local to the same memory buffer chips 200. A given memory page comprising a plurality of memory lines may e.g., be interleaved across the memory modules 272 of all memory buffer chips 200.

The computer system may, for example, include 16 processor chips 220, 230 and 240 and 128 memory buffer chips 200. In this case, each processor chip 220, 230 and 240 may include 128 ports 202 in order to be communicatively coupled to each of the memory buffer chips 200. Each of the memory buffer chips 200 can also be provided with 16 ports 202 such that each memory buffer chip 200 may be communicatively coupled to each processor chip 220, 230 and 240 through a distinct point-to-point communication connection 260.

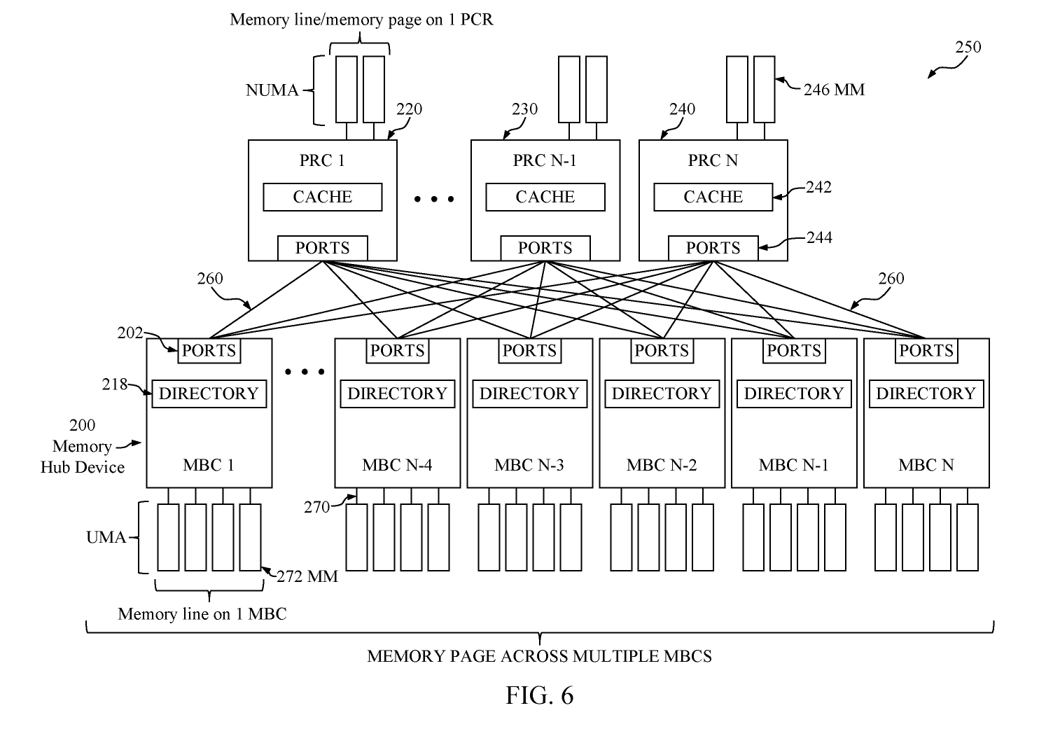

FIG. 6 depicts an embodiment of the multi-processor architecture 250 of FIG. 5. In the case of FIG. 6, at least one processor chips 220, 230 and 240 include one or more local memory modules 246. In the example of FIG. 6, each processor chip 240 includes two local memory modules 246. The memory modules 246, for example, may be dual in-line memory modules (DIMM) including a number of dynamic random-access memory ICs. The memory modules 246 can for example be implemented as phase change memory (PCM) or other types of memory storage technologies. As an example, at least one of the processor chips 240 may include no processor cores and may be optimized for accessing the local memory modules 246.

For at least one predefined address-based subset of memory lines stored in one or more of the memory modules 246 local to one of the processor chips 220, 230 and 240, each memory buffer chip 200 can include a coherence directory 218. A coherency directory 218 can be useful for implementing directory-based coherence for a line cached in the cache 242 of one or more processor chips 220, 230 and 240. Alternatively, all the memory buffer chips 200 can also include a distributed coherence directory 218 for implementing directory-based coherence for a predefined address-based set of memory lines stored in the memory modules 246, where each memory buffer chip 200 is in charge of its own unique address-based subset of memory lines.

Each processor chip 220, 230 and 240 may have memory access to each of the memory modules 272 local to memory buffer chips 200 and to each of the memory modules 246 local to each processor chip 220, 230 and 240. The access to the memory modules 272 can be through a uniform memory access (UMA) architecture, while the access to the memory modules 246 can be through a non-uniform memory access (NUMA) architecture. A given memory line, i.e., cache line, may be stored on at least one of the memory modules 246 local to the same processor chip 240. A given memory page including a plurality of memory lines may also be stored on at least one memory modules 246 local to the same processor chip 240. A memory page can, for example, be “scrambled” or distributed across a plurality of memory modules 246 local to the same processor chip 240.

Aspects of the present invention are described herein with reference to flowchart illustrations and/or block diagrams of methods, apparatus (systems), and computer program products according to embodiments of the invention. It can be understood that each block of the flowchart illustrations and/or block diagrams, and combinations of blocks in the flowchart illustrations and/or block diagrams, can be implemented by computer-readable program instructions.

The present disclosure may be a system, a method, and/or a computer program product. The computer program product may include a computer-readable storage medium, or media, having computer-readable program instructions thereon for causing a processor to carry out aspects of the present disclosure.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media, e.g., light pulses passing through a fiber-optic cable, or electrical signals transmitted through a wire.

Computer-readable program instructions described herein can be downloaded to respective computing/processing devices from a computer-readable storage medium or to an external computer or external storage device through a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the ‘C’ programming language or similar programming languages. The computer-readable program instructions may execute entirely on the user computer system's computer, partly on the user computer system's computer, as a stand-alone software package, partly on the user computer system's computer and partly on a remote computer or entirely on the remote computer or server. In the latter scenario, the remote computer may be connected to the user computer system's computer through any type of network, including a local area network (LAN) or a wide area network (WAN), or the connection may be made to an external computer (for example, through the Internet using an Internet Service Provider). In some embodiments, electronic circuit including, for example, programmable logic circuit, field-programmable gate arrays (FPGA), or programmable logic arrays (PLA) may execute the computer-readable program instructions by utilizing state information of the computer-readable program instructions to personalize the electronic circuit, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute through the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein includes an article of manufacture including instructions which implement aspects of the function/act specified in the flowchart and/or block diagram block or blocks.

The computer-readable program instructions may also be loaded onto a computer, other programmable data processing apparatus, or other device to cause a set of operations to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the FIGS. illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks depicted in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other variations to the disclosed embodiments can be understood and effected by those skilled in the art in practicing the claimed invention, from a study of the drawings, the disclosure, and the appended claims. In the claims, the word “comprising” does not exclude other elements or operations, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

1. A memory hub device for electrically interconnecting a set of memory devices to a main memory arrangement, the memory hub device comprising:
a first port configured to connect a first memory device of the set of memory devices to the memory hub device;
a second port configured to connect a second memory device of the set of memory devices to the memory hub device, the first port and the second port each configured to receive messages from the first memory device and the second memory device, respectively, the first port and the second port configured to transmit messages to the first memory device and the second memory device, respectively;
a transmission error detection and correction circuit configured to detect and correct transmission errors of messages received by the memory hub device;
a coherence protocol processing circuit configured to process messages received from the first and second memory devices; and
a switch fabric electrically coupled to the first port, to the second port and to the coherence protocol processing circuit, the switch fabric configured to selectively forward a first message received from the first memory device through the first port to the coherence protocol processing circuit, the switch fabric further configured to selectively bypass the coherence protocol processing circuit by forwarding the first message through the second port to the second memory device, the selective forwarding including at least one operation selected from a group consisting of:
cut-through forwarding, in response to a routing tag located in the beginning of the first message, the first message before receiving the first message in its entirety;
forwarding, after entirely receiving and performing an error detect and correct operation on the first message with the transmission error detection and correction circuit, the first message;
forwarding, after detection of an erroneous message that was transmitted to the memory hub device, a corrected version of the erroneous message; and
generating, storing, and subsequently forwarding a copy of the first message to the coherence protocol processing circuit for processing.

2. The memory hub device of claim 1, wherein the switch fabric is configured to select, based on content of the first message, a forwarding destination for the first message selected from a group consisting of: the coherence protocol processing circuit and the second port.

3. The memory hub device of claim 2, further comprising a message formatting circuit configured to format a second message to be transmitted to the first memory device, the second message requesting that the first message to be sent to the memory hub device, wherein the second message includes content to be copied into the first message, the portion content identifying the second memory device as a destination of the first message.

4. The memory hub device of claim 3, wherein the first message includes data from the first memory device, wherein the coherence protocol processing circuit is configured to initiate, through the message formatting circuit, the formatting of the second message in response to processing a third message through the second port, the third message received from the second memory device, the third message requesting that the data provided by the first memory device is sent to the second memory device.

5. The memory hub device of claim 2, wherein the content of the first message includes a routing tag based on a selected forwarding destination.

6. The memory hub device of claim 5, wherein the routing tag is included in a header of the first message.

7-9. (canceled)

10. The memory hub device of claim 1, wherein the transmission error detection and correction circuit is configured to detect and correct transmission errors of the first message at a time selected from a group consisting of: before the first message is transmitted by the memory hub device, and after the first message has been transmitted by the memory hub device.

11. The memory hub device of claim 10, wherein the transmission error detection and correction circuit is configured to forward a corrected first message to the second memory device through the second port.

12. The memory hub device of claim 1, wherein the switch fabric is configured to, in response to the first message being forwarded to the second memory device through the second port, generate a copy of the first message and forward the copy of the first message to the coherence protocol processing circuit.

13. The memory hub device of claim 1, wherein memory hub device is a memory buffer chip.

14. A memory device, the memory device electrically connected to a first port of a memory hub device, the memory device comprising a message formatting circuit configured to:
format a first message, the first message having a destination of the memory hub device;
include, within the first message, information that identifies a second memory device to which the first message is to be forwarded by the memory hub device;
format a second message to be transmitted to the first memory device, the second message including a request that the first message be sent to the memory hub device, wherein the second message includes information to be copied into the first message; and
format, in response to a coherence protocol processing circuit of the memory hub device, the second message upon processing a third message received from the second memory device through the second port.

15. The memory device of claim 14, wherein the message formatting circuit is configured to include the information into the first message by copying the information from the second message, the second message received by the memory device from the memory hub device.

16. The memory device of claim 14, wherein the information includes a routing tag.

17. The memory device of claim 15, wherein the routing tag is included within a header of the message.

18. The memory device of claim 14, wherein the memory device is a cache of a processor chip.

19-20. (canceled)

21. The memory hub device of claim 1, wherein at least one memory device is a cache memory of a processor chip.

22. The memory hub device of claim 1, wherein at least one memory device is a phase change memory (PCM) device.
